(19) United States
(12) Patent Application Publication
(10) Pub. No.: US 2010/0033350 A1
(43) Pub. Date: Feb. 11, 2010

(54) STANDBY INSTRUMENT FOR AN AIRCRAFT INSTRUMENT PANEL DETECTING OVERLOAD, PARTICULARLY DURING THE LANDING PHASE

(75) Inventors: Jerome Papineau, La Chapelle Encherie (FR); Lionel Collot, Vendome (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/442,428

(22) PCT Filed: Sep. 17, 2007
(86) PCT No.: PCT/EP2007/059779

§ 371 Date: Sep. 9, 2009

(30) Foreign Application Priority Data
Sep. 22, 2006 (FR) 0608332

(51) Int. Cl. G08B 23/00

(52) U.S. Cl. 340/967; 340/963; 340/969; 340/970

(57) ABSTRACT

The present invention relates to a standby instrument fitted to the instrument panel of an aircraft detecting overloads. The standby instrument includes a processor to calculate and display flight information based on data provided by associated sensors integrated into a standby system. It additionally includes a module for detecting overload of the aircraft on the basis of the data provided to display the flight information. The invention applies to the detection of overloads during a heavy landing. More generally, it applies to the detection and indication of overloads of an aircraft in various types of environment.

### CROSS-REFERENCE TO RELATED APPLICATION

This is a U.S. National Phase application under 35 U.S.C. §371 of International Application No. PCT/EP2007/059779, filed on Sep. 17, 2007, and claims benefit of French Patent Application No. 0608332, filed on Sep. 22, 2006, both of which are incorporated herein. The International Application was published on Mar. 27, 2008 as WO 2008/034795 under PCT Article 21(2).

### FIELD OF THE INVENTION

The present invention relates to a standby instrument fitted to the instrument panel of an aircraft detecting overloads. It applies notably in respect of the detection of overloads during a heavy landing. More generally, it applies in respect of the detection and indication of overloads of an aircraft in various types of environment.

### PRIOR ART

Environmental or technical conditions may compel an aircraft, for example an airliner, to undergo a heavy landing. During such a landing an overload of the aircraft may impair its structure and jeopardize its integrity in respect of future flights. These possible overloads must therefore be detected and an alert must be transmitted.

Current systems for detecting heavy landing generally comprise:
a set of sensors scattered around the aircraft, and in particular around the landing gear;
a data collection device, linked to the sensors, providing said data to means for estimating the overload experienced.

These current systems are distributed systems having notably the following drawbacks:
they require a complex installation, in particular 15 to 40 sensors for example to be scattered and linked to the data collection device, itself combined with processing means or directly with a display;
they exhibit a significant mass, due in particular to the weight of the cabling;
they have only limited reliability on account notably of the number of components used;
they are expensive since the whole of a system is dedicated solely to the overload detection function.

An aim of the invention is notably to alleviate the aforesaid drawbacks. For this purpose, the subject of the invention is a standby instrument fitted to the instrument panel of an aircraft, comprising means for calculating and displaying flight information on the basis of data provided by associated sensors integrated into a standby system, the instrument comprising a module for detecting overload of the aircraft on the basis of the data provided for displaying the flight information.

The overload detection module uses for example the information provided by an inertial sensor, an overload detection corresponding to a heavy acceleration of the aircraft combined with at least one environmental information item provided by the associated sensors.

An environmental information item may be the altitude of the aircraft, the speed of the aircraft or else the inclination of the aircraft.

Advantageously, the standby instrument displays an overload detection signal, for example on the main screen which indicates the flight information.

The module stores for example the detections of overload arising in the flight phase, a secondary screen displaying the information relating to these detections.

### BRIEF DESCRIPTION OF DRAWINGS

Other characteristics and advantages of the invention will become apparent with the aid of the description which follows offered in relation to appended drawings which represent:

FIG. 1, an illustration of a standby instrument in its operational environment;

FIG. 2, an exemplary display on the main screen of a standby instrument;

FIG. 3, through a schematic an exemplary embodiment of a standby instrument according to the invention;

FIG. 4, an exemplary display of an overload information item on a standby instrument according to the invention.

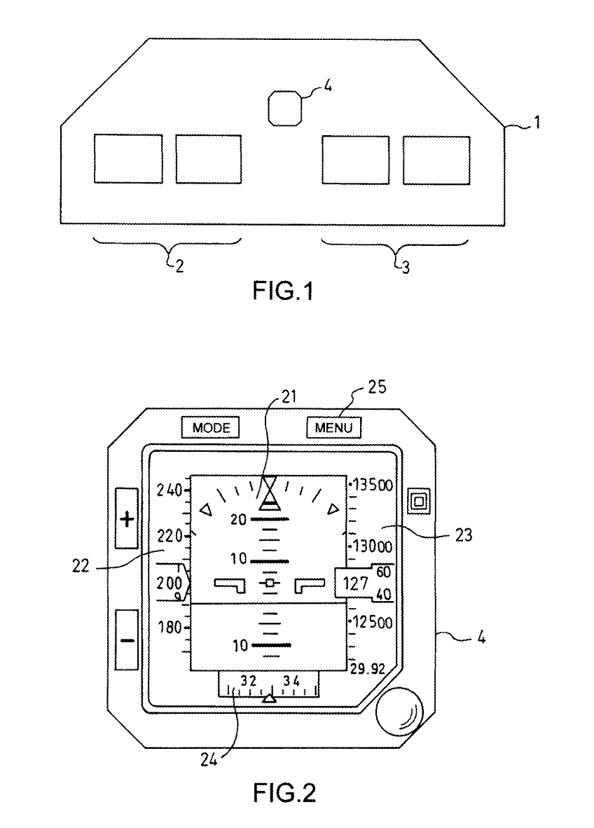

FIG. 1 illustrates a standby instrument 4 in its operational environment. The standby instrument 4, also called standby combined instrument, is used notably in the event of a fault with the primary viewing screens with which the instrument panel of an aircraft is equipped.

Thus, FIG. 1 presents in a schematic manner, by way of example, an instrument panel 1 of an airliner. This instrument panel comprises two groups of viewing screens 2, 3. Each group comprises a screen presenting notably altitude, speed and attitude information and a screen presenting navigation information. The two groups 2, 3 are identical, one being reserved for the pilot and the other for the copilot. These two groups form the primary viewing screens. The standby instrument 4 is placed between these two primary viewing groups. The standby instrument of FIG. 1 presents at least altitude, speed and attitude information for the airplane.

Airliners are therefore equipped with a standby instrument 4, of the electronic type, such as presented in FIG. 1. It is equipped on the one hand with pressure sensors so as to display the essential information and on the other hand with one or more inertial sensors so as to provide navigation information, in particular the attitude of the airplane.

FIG. 2 illustrates by way of example the display screen of the standby instrument 4 in its standard function. A first area 21 of the screen presents the attitude of the airplane symbolized by its wings with respect to the horizon line 211. A second area 22 displays the speed of the airplane and a third area 23 displays the altitude of the airplane. In addition to these three essential items of information, other information can be exhibited on one and the same page.

In the example of FIG. 2, an area 24 is reserved for the heading information. By pressing a specific button 25, another page may be displayed to exhibit, for example, navigation information or other information. In the event of a defect of display of the primary viewing screens 2, 3, the screen of the standby instrument 4 is used by the pilots. In the flight phase, the pilots nevertheless observe the screen of the standby instrument and note any problems possibly displayed by the latter.

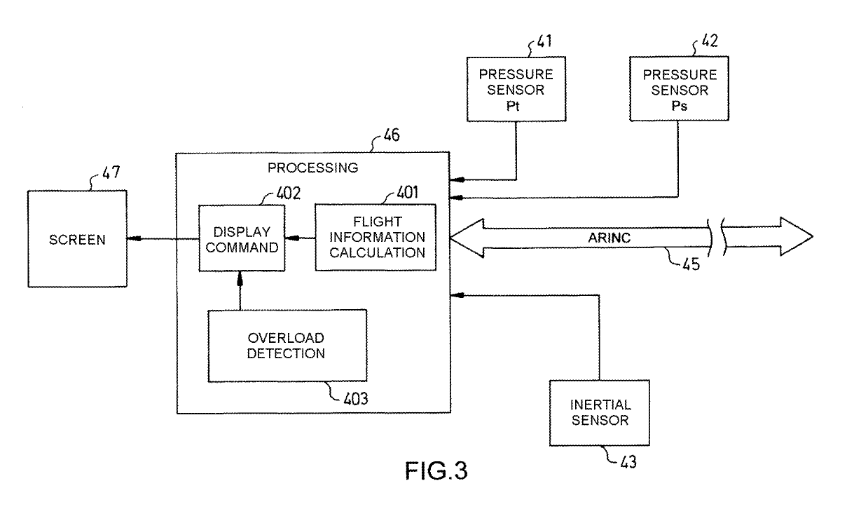

FIG. 3 illustrates through a schematic representation a standby instrument for implementing a device according to the invention. Such an instrument is integrated into a standby system, the components of the system being or not being integrated into the standby instrument. The standby system comprises notably at least one total pressure sensor 41 and one static pressure sensor 42 so as to make it possible to generate information, essential to the flight, regarding airplane altitude, speed and attitude. Additionally, the standby system also comprises one or more inertial sensors 43 for providing airplane attitude information. These various sensors 41, 42, 43 can be situated inside or outside the standby instrument. The latter can also receive information, notably navigation information, provided by other systems via a bus 45, in particular the ARINC aircraft bus.

The information provided by these sensors or this bus reaches processing means 46 internal to the standby instrument. These processing means utilize the information coming from the various external sensors or systems.

A prime function of a standby combined instrument such as illustrated by FIGS. 1 and 2 is to display on its screen 47 the flight information, this information being notably the altitude, the speed and the attitude of the airplane. This information is produced in a known manner by processing means 46. In particular, the processing means 46 comprise a module 401 for calculating the various flight parameters to be displayed as a function of the information received from the sensors, this module additionally storing this information. The calculated parameters are thereafter provided to a command module 402 for controlling the display on the screen 47 with a view to producing the various representations of these parameters.

A standby instrument according to the invention additionally comprises a module 403 for detecting overloads. This module 403 has the same information as the module 401 for calculating the flight parameters, this information coming from the various sensors 41, 42 and in particular the inertial sensor 43. The module 403 processes this information with the aim notably of detecting overloads. The overload information due for example to a heavy landing, to strong turbulence or to high load factors is provided by the inertial platform 43. In particular, an overload can be detected by an abrupt change of attitude and more particularly by an abrupt rotational or translational movement, a movement readily detectable by an inertial platform. The module 403 is additionally able to corroborate this abrupt movement information with flight parameters, such as the altitude of the airplane, its speed, its inclination or else the speed of the air. The module 403 can thus make the connection between an abrupt movement of the airplane, its situation and its environment. Thus, an abrupt movement detected in the landing phase indicates an overload on landing. The module 403 provides the overload detection information item to the display control module 402. Additionally, it retains in memory the overload detection for the use of the maintenance services.

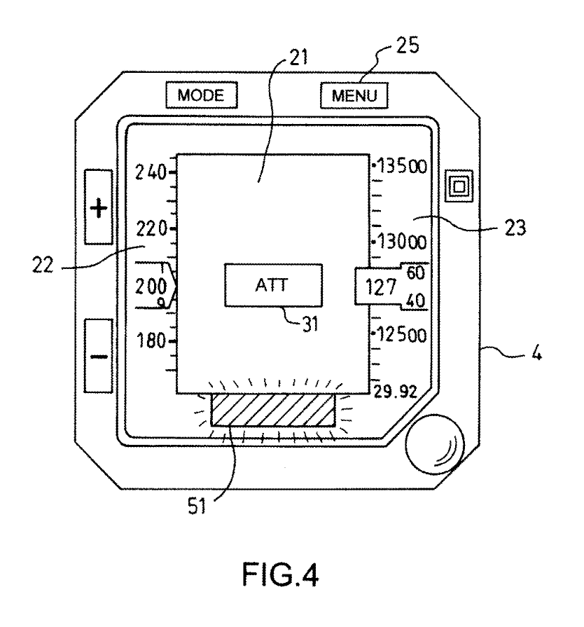

FIG. 4 illustrates a possible example of the overload detection information item on the screen of the standby instrument 4. An overload detection can be displayed according to two modes. FIG. 4 presents a first mode of display where the overload is, for example, indicated by a signal 51 on the main screen of the standby instrument. The signal 51 can be a luminous signal, flashing or not, displaying for example the information item “overload”.

The main screen is the screen which displays the standard information in the flight phase. This alert is, for example, disposed at the bottom of the screen and does not impair the display of the essential altitude, speed and attitude information of the airplane. This display is a real-time display since the alert is produced at the moment of the overload. A second mode of display presents the overload information item recorded. This information item, stored by the overloads processing module 403 is, for example, presented on an additional graphical page of the standby instrument, accessible in the maintenance phase. This additional graphical page can moreover display all the overloads that have occurred in the latest landing phase and also for the previous landing phases.

A standby instrument according to the invention therefore makes it possible notably:
to detect heavy landings on the basis of the information at its disposal for its standard functions;
to display alerts 51 so as to provide the pilot with a monitoring element;
to record the overload levels detected for the latest landings.

Advantageously, the detection of the overloads is independent of the primary devices, that is to say of the primary viewing screens 2, 3 and of their associated sensors. Specifically, the standby instrument according to the invention combines the overload information, determined by a heavy acceleration, with the flight information available in an autonomous manner on the standby instrument.

1. A standby instrument fitted to the instrument panel of an aircraft, comprising:
a processor to calculate flight information based on data provided by one or more associated sensors integrated into a standby system;
a display to display the flight information; and
an overload detection module to detect overload of the aircraft based on the data provided for displaying the flight information.

2. The standby instrument as claimed in claim 1, wherein the overload detection module uses information provided by an inertial sensor combined with at least one environmental information item provided by the one or more associated sensors, wherein the inertial sensor includes an overload detector configured to detect a heavy acceleration of the aircraft.

3. The standby instrument as claimed in claim 2, wherein an environmental information item includes an altitude of the aircraft.

4. The standby instrument as claimed in claim 2, wherein an environmental information item includes a speed of the aircraft.

5. The standby instrument as claimed in claim 2, wherein an environmental information item includes an inclination of the aircraft.

6. The standby instrument as claimed in claim 1, wherein the standby instrument displays an overload detection signal.

7. The standby instrument as claimed in claim 6, wherein the overload detection signal is displayed on a main screen that displays the flight information.

8. The standby instrument as claimed in claim 6, wherein the overload detection module further comprises a secondary screen to display information relating to overload of the aircraft.
